(19) United States
(12) Patent Application Publication
(10) Pub. No.: US 2005/0228721 A1
(43) Pub. Date: Oct. 13, 2005

(54) Authentication system and method for providing access for a subsystem to a password-protected main system

(76) Inventor: Ralf Hofmann, Nuernberg (DE)

Correspondence Address: HARNESS, DICKEY & PIERCE, P.L.C., P.O.BOX 8910, RESTON, VA, 20195, US

(21) Appl. No.: 11/093,280

(22) Filed: Mar. 30, 2005

Related U.S. Application Data
(60) Provisional application No. 60/557,692, filed on Mar. 31, 2004.

(30) Foreign Application Priority Data
Mar. 31, 2004 (DE) 10 2004 016 579.3

(51) Int. Cl. G06F 17/60

(52) U.S. Cl. 705/18

(57) ABSTRACT

An authentication system is proposed, for providing access for at least one subsystem to at least one password-protected main system. The authentication system includes a memory device for storing at least one reference key for the at least one subsystem and at least one reversibly coded password for the main system. It further includes a reception device for receiving a prescribed key stored in the subsystem. In addition, a comparison device is included for comparing the received key with the at least one reference key stored in the memory device. Further, a decoding device is used for reading and decoding the at least one reversibly coded password for the at least one main system which is stored in the memory device, if the requested key matches the reference key. Finally, an output device is included for outputting the decoded password to the main system in order to provide access for the subsystem. In addition, a method is proposed for providing access for at least one subsystem to at least one password-protected main system using an authentication system.

The present application hereby claims priority under 35 U.S.C. §119 on German patent application number DE 10 2004 016 579.3 filed Mar. 31, 2004, and on U.S. provisional patent application Ser. No. 60/557,692 filed Mar. 31, 2004, the entire contents of each of which are hereby incorporated herein by reference.

### FIELD OF THE INVENTION

The present invention generally relates to an authentication system and to a method and an apparatus for providing access for a subsystem to a password-protected main system.

### BACKGROUND OF THE INVENTION

Document US 2002/0087866 A1 discloses an interposed system which provides remote clients with access to a primary system, such as a server. For this, the interposed system creates and stores a registration data record for each client.

In this case, a separate registration data record is created for each client for each primary system which the client wishes to access. The registration data record contains encrypted identification information for the client in the primary system. This identification information contains authentication information for checking a client's authorization to access the primary system. The authentication information includes a client identification and a client password for registering the client on the primary system.

When a client attempts to register with the primary system, the interposed system first checks the client's access authorization using the registration data record and information which is provided by the client. The interposed system then forwards the identification for the client in his primary system to the primary system, which checks the client's authorization to access the primary system.

Many medical appliances, particularly medical appliances in medical imaging, use standard operating systems (e.g. OS2, Unix or MS Windows) in order to handle and archive measured data which have been captured. In this case, the respective standard operating system uses not only the data management and management of system resources, but also mechanisms to provide data integrity and access control.

Such monitoring of the data integrity and access control is very important, particularly in the field of medical engineering, since the measured data which are captured are normally sensitive patient data.

A typical access controller in a standard operating system essentially has an encryption device and a comparator.

A codeword which is input by a user is encrypted by the encryption device and is transmitted to the comparator for further processing. In this case, the encryption is irreversible for security reasons.

The comparator accesses an irreversibly encrypted reference codeword stored on the standard operating system and compares it with the irreversibly encrypted codeword which has been input by the user.

If there is a match, access to the standard operating system and to data managed by the standard operating system is permitted.

On the other hand, if the comparator returns the result that the codeword which has been input by the user and which has been irreversibly encrypted by the encryption device does not match the irreversibly encrypted reference codeword stored by the standard operating system, access to the standard operating system and to data managed by the standard operating system is refused.

Hence, when a user registers in a standard operating system, at no time is the unencrypted codeword forwarded (e.g. via a network) or stored (for example on a hard disk). Thus, the codeword cannot be spied out by an unauthorized third party either. Accordingly, the access control used by standard operating systems is particularly secure.

Particularly in the field of medical engineering, the use of the access control from a standard operating system entails a few serious drawbacks, however:

First, the large volume of patient data obtained using medical appliances indicates that it is frequently necessary for the data not to be processed further until a time which is significantly after the time at which the data are obtained. In particular, such processing frequently takes place at night when sufficient unused computation capacity is available (for example in a network). The result of this is that the data obtained by the medical appliance are frequently not forwarded from the medical appliance to a network, for example, via a standard operating system until a time at which the actual user of the medical appliance is no longer present.

Since—as explained above—standard operating systems normally have an access controller, such access by the medical appliance to a network via a standard operating system or to a standard operating system integrated in the medical appliance in the absence of a user is normally not possible.

To solve this problem, the prior art has various approaches.

In line with a first approach, the user remains permanently (and hence also when he is not there) registered in the standard operating system via the medical appliance and thus allows the medical appliance to access the standard operating system.

This practice has the drawback that the user may be registered in the standard operating system for very long times in his absence. Thus, an unauthorized third party can easily obtain access to the standard operating system and to the data managed by the standard operating system via the user who is registered. In addition, the result of users logging on permanently is that the standard operating system's access control is undermined and is no longer handled with the required care by the users.

Alternatively, it is known practice for the manufacturer to equip medical appliances with a standard codeword which allows the medical appliance to register on a standard operating system provided that the codeword has been disposed on the standard operating system beforehand.

This practice has the drawback that the standard codewords used by the medical appliances can easily become accessible to an unauthorized group of people on account of the sometimes large quantities of the medical appliances. Once an unauthorized third party has obtained access to such a standard codeword, this unauthorized third party can use the standard codeword to register in all standard operating systems which he knows to have a corresponding medical appliance connected.

Another important problem regarding access control in medical appliances is that a medical appliance needs to be set up to be used by any third party in an emergency without this requiring lengthy registration and without the arbitrated person having a codeword. Even if, in this “emergency mode” of the medical appliance, it is normally necessary and possible to use only a limited scope of functions, this generally requires access to the standard operating system.

In summary, the previously known possibilities for allowing a medical appliance to access a standard operating system even in the absence of the actual user are inadequate, since the access control in the standard operating system has its effectiveness significantly reduced either through the use of standardized passwords or through a user being permanently logged on.

### SUMMARY OF THE INVENTION

It is an object of an embodiment of the present invention to provide an authentication system and/or a method for providing access for a subsystem to a password-protected main system which allow the subsystem to register reliably in the password-protected main system, even in the absence of a user and which are nevertheless protected against misuse.

An object may be achieved, in one embodiment, by a method for providing access for at least one subsystem to at least one password-protected main system.

In addition, an object may be achieved, in one embodiment, by an authentication system for providing access for at least one subsystem to at least one password-protected main system.

In line with an embodiment of the invention, a method for providing access for at least one subsystem to at least one password-protected main system using an authentication system has the following steps:
a prescribed key stored in the subsystem is received by the authentication system;
the requested key is compared with a reference key stored in the authentication system;
a reversibly coded password for the main system which is stored in the authentication system is read and decoded if the requested key matches the reference key; and
the decoded password is output to the main system in order to provide access for the subsystem.

Since an embodiment of the invention allows a subsystem to access the main system only after a prescribed key stored in the subsystem has been compared with a reference key stored in the authentication system, the embodiment of the inventive method allows the subsystem to access the main system in particularly reliable fashion while maintaining the highest possible level of data integrity and system security. In this case, it is necessary neither for a user to have to input a respective password nor for the subsystem to have a standard password stored for the main system or for a user to be permanently logged on in the main system.

Since the prescribed keys stored in the respective subsystems are not passwords for the main system (and hence do not allow access to the main system on their own) but rather merely need to match reference keys stored in the authentication system, different keys can be prescribed for various subsystems and corresponding reference keys can be stored in the respective authentication systems, regardless of the main systems used in each case. This greatly limits the potential for damage by misuse of a disclosed key from a subsystem by an unauthorized third party.

At the same time, access to a respective main system is possible only for subsystems which are authorized by the respective authentication system, since the prescribed keys stored in the respective subsystems need to match the reference keys stored in the respective authentication system. Misuse by unauthorized third parties can thus be effectively avoided.

It is also readily possible to change the prescribed key(s) stored in a subsystem and the reference key(s) stored in the respective authentication system without the need to change a password for the main system. The inventive solution of at least one embodiment is thus particularly flexible.

Since, in addition, the passwords for the main system are stored in the authentication system in reversibly coded form, it is possible to create a security copy of the reversibly coded password. This security copy allows—unlike a security copy of the irreversibly coded passwords in a standard operating system—the passwords to be set up again, for example after a system restore in the main system, which eliminates time-consuming reallocation of passwords for the main system.

Since the inventive method of at least one embodiment for providing access for at least one subsystem to at least one password-protected main system is also based on the access control in the main system, the access control security, which the main system's access control ensures, may be essentially maintained.

In line with an embodiment of the present invention, the step of the prescribed key stored in the subsystem being received by the authentication system may be preceded by the following steps:
a request by the subsystem to access the main system is recorded by the authentication system; and
a prescribed key stored in the subsystem is requested by the authentication system.

The fact that the prescribed key stored in the subsystem is requested by the authentication system means that suitable coding of the request makes it possible to ensure that the prescribed key stored in the subsystem cannot easily be read by an unauthorized third party. This further increases the resistance of at least one embodiment of the inventive method toward manipulation.

If a plurality of passwords for a plurality of users are stored in the authentication system, at least one embodiment of the inventive method may include the following steps in addition:
the last reversibly coded password stored is identified; and
this password is used to provide access for the subsystem.

This firstly ensures that passwords which are as up-to-date as possible are always used for providing access for the subsystem to the main system.

In addition, when providing access for the subsystem to the main system, this always produces a reference to the last user, which is significant in as much as it is highly probable that the last user has performed the action which resulted in access to the password-protected main system being requested for the subsystem.

It may be particularly advantageous if the method at least one embodiment of also has the following steps:
the uncoded password received from the authentication system is irreversibly encrypted by the main system;
the irreversibly encrypted password is compared with an irreversibly encrypted reference password stored in the main system; and
the main system enables access if the irreversibly encrypted password matches the irreversibly encrypted reference password.

As such, the unencrypted password may never be transmitted or stored in the main system. As a result of this, the password may be protected particularly well against manipulation and unauthorized access. It is also thus possible to use password routines which are used in standard operating systems.

So that the inventive method of at least one embodiment can be used for automatic detection of passwords for the main system by the authentication system, it the method of at least one embodiment additionally may include the following steps:
a user password is requested by the authentication system;
the password is reversibly coded by the authentication system; and
the reversibly coded password is stored by the authentication system.

This allows passwords for the main system to be automatically detected in a particularly simple manner. Since the passwords are stored in the authentication system not in plain text but rather in coded form, the inventive solution of at least one embodiment may be resistant toward manipulation.

In this case, it is particularly advantageous if at least one embodiment of the method also has the step of the uncoded password being forwarded to the main system by the authentication system in order to provide access for the user.

It is thus a simple matter for at least one embodiment of the inventive method to precede the usual recording/registration of a user in the main system. In addition, the list of reversibly coded passwords which is stored in the authentication system is thus automatically kept up to date. There is also no need for special training for the users of the authentication system or for particular complexity in order to detect the passwords for the main system.

An object may also be achieved by at least one embodiment of the inventive authentication system for providing access for at least one subsystem to at least one password-protected main system which has the following elements:
a memory device for storing at least one reference key for the at least one subsystem and at least one reversibly coded password for the main system;
a reception device for receiving a prescribed key stored in the subsystem;
a comparison device for comparing the requested key with the at least one reference key stored in the memory device;
a decoding device for reading and decoding the at least one reversibly coded password for the at least one main system which is stored in the memory device if the requested key matches the reference key; and
an output device for outputting the decoded password to the main system in order to provide access for the subsystem.

The reception device may also be set to record a request by the subsystem for access to the main system and to request a prescribed key stored in the subsystem.

It also may be advantageous if the decoding device in at least one embodiment of the inventive authentication system is also set to identify the last reversibly coded password for the main system which is stored in the memory device and to use this password to provide access for the subsystem.

It may be particularly advantageous if the main system is set to encrypt the uncoded password received from the authentication system irreversibly, to compare the irreversibly encrypted password with an irreversibly encrypted reference password stored in the main system, and to enable access to the main system if the irreversibly encrypted password matches the irreversibly encrypted reference password.

In line with one particular embodiment, the inventive authentication system also includes, for the purpose of automatically detecting passwords for the main system, an input device for requesting a user password and a coding device for reversibly coding the requested password and storing the reversibly coded password in the memory device.

In this case, it may be particularly advantageous if the input device is also set up to forward the uncoded password to the main system in order to provide access for the user.

Since the problem of providing access for at least one subsystem to at least one password-protected main system occurs with particular frequency in the field of medical engineering, it may be particularly advantageous if at least one embodiment of the inventive authentication system is integrated in a medical appliance.

It may then also be advantageous if the at least one subsystem is an emergency circuit in the medical appliance which allows the medical appliance to operate by accessing the main system without password input.

This makes it a particularly simple matter to use a suitable key switch, for example, to permit emergency operation of the medical appliance without password input and in so doing to ensure access to the main system without the need to prescribe and/or disclose a password for the main system.

At least one embodiment of the inventive authentication system and the main system may be implemented in the form of different computer programs.

An object may also be achieved by a computer program product which is suitable for performing a method of at least one embodiment, when it is loaded on a computer.

### BRIEF DESCRIPTION OF THE DRAWINGS

The detailed description below gives a more detailed description of an example embodiment of the present invention with reference to the appended drawings, in which

FIG. 1 shows a block diagram of at least one embodiment of the inventive authentication system in line with a preferred embodiment; and

FIGS. 2a, 2b show a flowchart of the inventive method for providing access for at least one subsystem to at least one password-protected main system in line with a particular embodiment.

### DETAILED DESCRIPTION OF THE EXAMPLE EMBODIMENTS

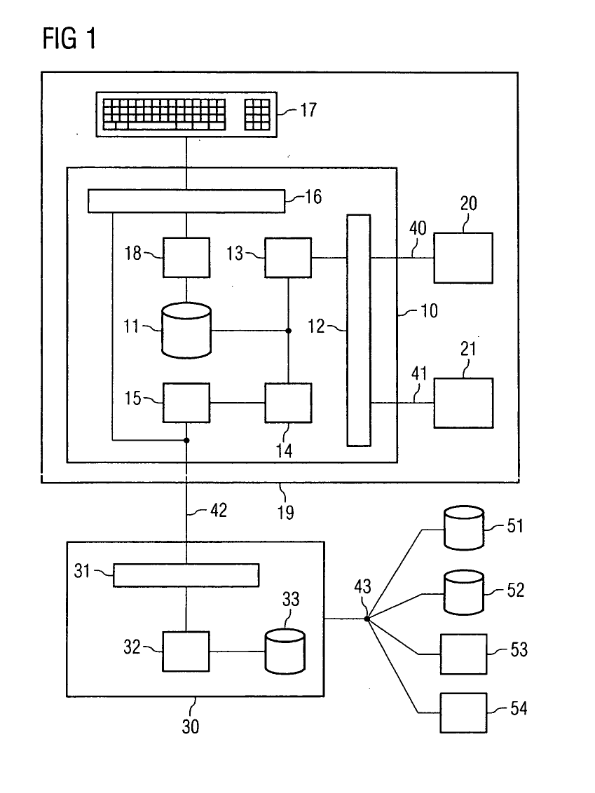

FIG. 1 shows an example embodiment of the inventive authentication system 10 for providing access for at least one subsystem 20, 21 to at least one password-protected main system 30.

The authentication system 10 shown in FIG. 1 is integrated in a medical appliance 19 and has a memory device 11, a reception device 12 connected to the memory device 11 via a comparison device 13, an output device 15 connected to the memory device 11 via a decoding device 14, and an input device 16 connected to the memory device 11 via a coding device 18.

The input device 16 is connected to a user interface 17 (in the embodiment shown an input keypad on the medical appliance 19).

In the example embodiment shown in FIG. 1, the reception device 12, the comparison device 13, the decoding device 14, the output device 15, the input device 16 and the coding device 18 are provided by various microprocessors in the inventive authentication system 10 (which are connected to one another in suitable fashion) and access a common memory device 11.

Alternatively, however, it is also possible to combine the reception device 12, the comparison device 13, the decoding device 14, the output device 15, the input device 16 and the coding device 18 in one or more microprocessors.

In addition, in the example embodiment shown in FIG. 1, the memory device 11 is a hard disk. Alternatively, however, it is also possible to use another nonvolatile memory.

The medical appliance 19 shown in FIG. 1 is a magnetic resonance tomograph. Alternatively, however, it may also be any other, preferably imaging, appliance in medical engineering. Naturally, embodiments of the present invention are not limited to the field of medical engineering, but rather may also be used in other fields of engineering.

The inventive authentication system 10 of at least one embodiment shown in FIG. 1 is connected to a first and a second subsystem 20 and 21 by connecting lines 40 and 41.

In this example embodiment, the subsystems 20 and 21 are likewise part of the medical appliance 19.

In this particular embodiment, the subsystem 20 is an emergency circuit in the medical appliance 19, the emergency circuit being able to be operated by way of a key switch and allowing the medical appliance 19 to operate by accessing a main system 30, connected to the medical appliance 19, even without password input.

In this embodiment, the subsystem 21 is a main processor on which a program is loaded which controls the operation of the medical appliance 19.

It is obvious that at least one embodiment of the inventive authentication system 10 may alternatively also be connected to just one or to more than two subsystems. The subsystems may be integrated in the medical appliance 19 or may be in the form of separate appliances.

The output device 15 and the input device 16 are connected to an encryption device 31 in a main system 30 by way of a connecting line 42.

The main system 30 shown in FIG. 1 is a clinic server which is connected to the medical appliance 19 and which permits access to archive memories for patient data 51 and 52 and network computers 53 and 54 which are connected to the clinic server 30 via a network 43.

The main system 30 is controlled by a standard operating system (in the present case UNIX) and has an access control device which is in the form of an encryption device 31, a comparator 32 connected to the encryption device 31 and a hard disk 33 connected to the comparator 32.

The inventive authentication system's memory device 11 stores a respective reference key for each subsystem 20 and 21. In this case, the reference key may also be stored in encrypted form. In addition, the memory device 11 stores a plurality of reversibly coded passwords for the main system.

The reception device 12 is connected to the subsystems 20 and 21 via the connecting lines 40 and 41 and is suitable for recording a request from the subsystem 20 or the subsystem 21 for access to the main system 30 and for requesting a prescribed key which is stored in the respective requesting subsystem 20 or 21.

The keys stored in the subsystems 20 and 21 are special components which have been rendered accessible only to at least one embodiment of the inventive authentication system and to the manufacturer of the medical appliance 19. A third party (for example a user of the medical appliance 19) or a manufacturer of any other appliances which can be connected to the medical appliance 19 has no access to the keys. In the example embodiment shown in FIG. 1, the keys are permanently stored in the subsystems 20 and 21 in nonvolatile solid-state memories.

The comparison device 13 in at least one embodiment of the inventive authentication system is designed to compare a key, requested by the reception device 12, from a subsystem 20 or 21 with a reference key, stored in the memory device 11, for the subsystem 20 or 21 and to read the memory device 11 for this purpose.

If the key requested from the subsystem 20 or 21 via the reception device 12 matches the reference key stored in the memory device 11, the comparison device 13 outputs a signal to the decoding device 14.

If the decoding device 14 receives a signal from the comparison device 13 indicating that the match between a key requested from a subsystem 20 or 21 via the reception device 12 and a reference key stored in the memory device 11 exists, the decoding device 14 in the example embodiment shown in FIG. 1 automatically identifies the last reversibly coded password for the main system 30 which is stored in the memory device 11 (or the password for the main system 30 which was used last), reads the last stored reversibly coded password for the main system 30 from the memory device 11 and decodes the password.

The last reversibly coded password for the main system 30 which is stored in the memory device 11 or the last password used for accessing the main system 30 can naturally be identified only if the memory device 11 stores a respective password for the main system 30 for a plurality of users, and hence therefore a plurality of passwords.

The use of the respective last reversibly coded password stored automatically sets up a reference to the last user of the medical appliance 19.

It is obvious that the use of the last reversibly coded password stored is not absolutely essential. Alternatively, for example for the respective subsystem 20, 21, a respective common or different user may be prescribed which the respective subsystem 20, 21 uses to identify itself, i.e. whose identity and hence whose password for the main system 30 the subsystem 20, 21 wishes to use to access the main system 30.

The only crucial element is for there to actually be a reversibly coded password for a user stored for the main system 30 in the memory device 11 in at least one embodiment of the inventive authentication system 10, which a respective subsystem 20, 21 can use (including the identity) to access the main system 30.

From this, it becomes clear that, within the context of at least one embodiment of this invention, the reversibly coded password stored in the memory device 11 in at least one embodiment of the inventive authentication system 10 is understood to mean all information which is required for a user to register successfully with the main system 30. Hence, besides the actual password, the reversibly coded password may also include, by way of example, a user identifier (a login) for the user and/or the indication of a domain path etc.

Next, the decoding device 14 forwards the coded password for the main system 30 to the output device 15.

The output device 15 outputs the decoded password to the main system 30 in order to provide access for the respective subsystem 20 or 21.

In the exemplary embodiment shown in FIG. 1, an uncoded password received from the output device 15 in the authentication system 10 in the medical appliance 19 is irreversibly encrypted by the main system 30 using an encryption device 31.

The password irreversibly encrypted by the encryption device 31 is output by the encryption device 31 to a comparator 32 in the main system 30 and is compared by the comparator 32 with an irreversibly encrypted reference password stored on a hard disk 33 in the main system 30.

If the comparator 32 establishes that the password irreversibly encrypted by the encryption device 31 matches an irreversibly encrypted reference password stored on the hard disk 33, the comparator 32 outputs a signal which enables access to the main system 30 via the connecting line 32.

When access to the main system 30 is enabled, the respective subsystem 20 or 21 is connected to the main system 30.

In the particular example embodiment shown in FIG. 1, the encryption device 31 and the comparator 32 are integrated in a standard operating system in the main system 30. After access has been enabled, the standard operating system in the main system 30 permits access to archive memories 51, 52 and network computers 53, 54 which are connected to the main system 30 via a network 43.

Thus, for example when the emergency circuit 20 in the medical appliance 19 is operated without interaction by a user, i.e. without password input by a user, it is possible to access the network 43 using the password-protected main system 30. This access may possibly be limited by the respective subsystem (in this case the emergency circuit 20).

Since at least one embodiment of the inventive authentication system thus continues to use the access mechanism in the main system 30, at least one embodiment of the inventive authentication system does not cancel the protection against unauthorized access which the main system provides.

When a subsystem 20, 21 uses at least one embodiment of the inventive authentication system 10 to register access to the main system, this is done not by transmitting a password for the main system but rather using a prescribed key which is stored in the subsystem 20 or 21. This prevents passwords for the main system from being stored in the subsystem or being transmitted in uncoded form and being able to be read easily by unauthorized third parties.

The automatic check on the keys stored in the subsystems using reference keys stored in at least one embodiment of the inventive authentication system indicates that manipulation of at least one embodiment of the inventive authentication system is possible only with very great difficulty.

In addition, at least one embodiment of the inventive authentication system is particularly flexible on account of the decoupling of the passwords for the main system from the subsystems by way of the keys stored in the subsystems.

As a result, at least one embodiment of the inventive authentication system firstly allows access to the main system to be provided for at least one subsystem in a particularly simple and reliable manner while maintaining the greatest possible data integrity and system security and without the need for interactive password input by a user or for a user to be permanently logged on in the main system.

In addition, the coded storage of the passwords for the main system indicates that the inventive authentication system allows the creation of security copies of the coded passwords for the main system, so that the passwords for the main system 30 can be restored using the inventive authentication system in the event of a system restore in the main system 30, and setting up all of the passwords again in time-consuming fashion is dispensed with.

To be able to detect passwords for the main system 30 automatically, at least one embodiment of the inventive authentication system 10 which is shown in FIG. 1 has the input device 16, which is connected to the keypad 17 on the medical appliance 19.

The keypad 17 and the input device 16 can be used to request a user password for the main system 30 (e.g. when a user wishes to access the main system 30 or wishes to start the medical appliance 19).

The password requested by the input device 16 using the keypad 17 is forwarded to the coding device 18, which reversibly codes the requested password and stores it in the memory device 11 in the inventive authentication system 10 in the form of a reversibly coded password.

In addition, the input device 16 forwards the password for the main system which the user has input using the keypad 17 to the main system 30 via the connecting line 42 in order to provide the user with access to the main system 30.

If the user password for the main system 30 is changed, this is automatically detected by at least one embodiment of the inventive authentication system 10 at the same time and the changed password is stored in the memory device 11 in reversibly coded form.

At least one embodiment of the inventive authentication system 10 thus always has the respective current passwords for the main system 30 available automatically. In addition, no special involvement and no special training for a user of the medical appliance 19 is required in order to detect the passwords for the main system.

In the example embodiment shown in FIG. 1, the authentication system 10 and the main system 30 are implemented in the form of different computer programs. In this case, the main system 30 is not part of the medical appliance 19.

In line with an alternative embodiment (not shown in the figures) , the main system 30 may also be part of the medical appliance 19, however.

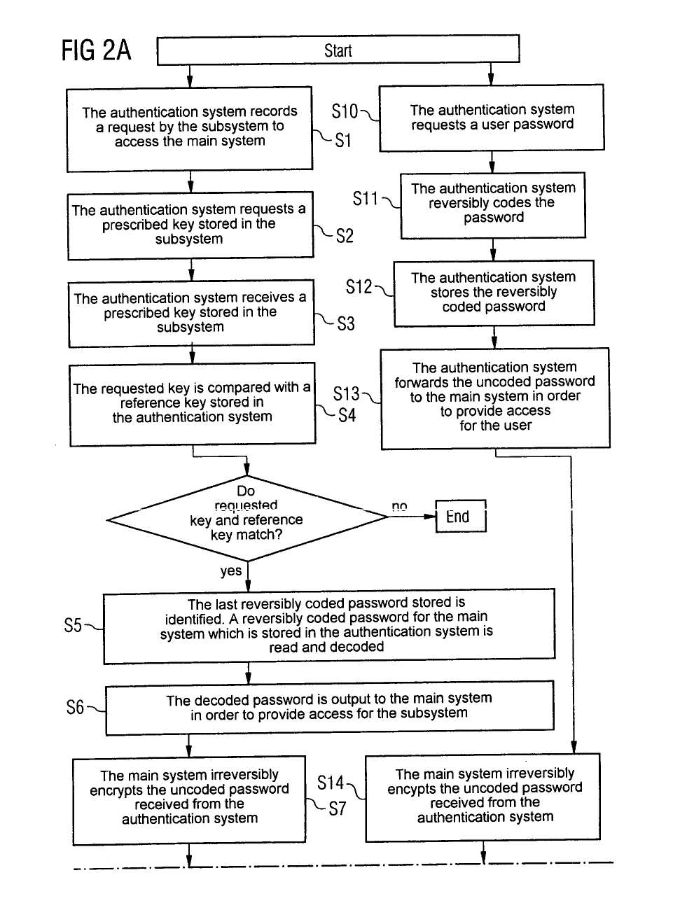

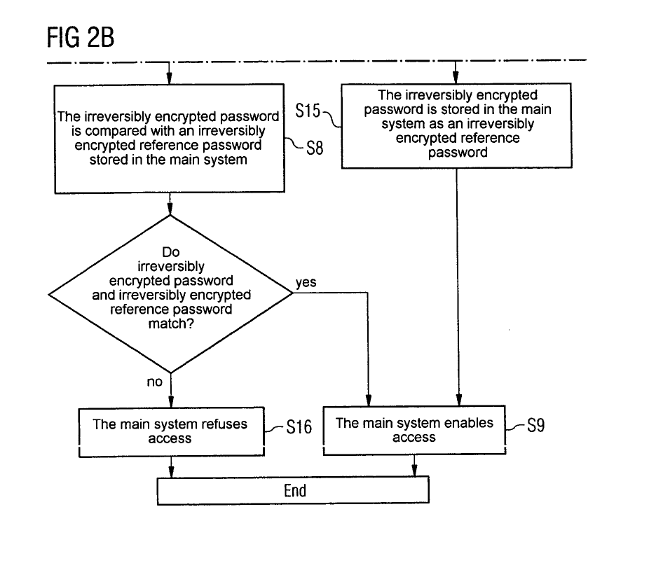

The text below describes at least one embodiment of the inventive method for providing access for at least one subsystem 20, 21 to at least one password-protected main system 30 using the authentication system 10 shown in FIG. 1 with reference to FIGS. 2a and 2b.

In a first step S1, the reception device 12 in the authentication system 10 records a request by a subsystem 20, 21 to access the main system 30.

In the next step S2, a prescribed key stored in the subsystem 20 or 21 is requested by the reception device 12 in the authentication system 10.

In the next step S4, the key received by the authentication system 10 in this manner (step S3) is compared by the comparison device 13 in the authentication system 10 with a reference key stored in the memory device 11 in the authentication system 10.

If the comparison device 13 in the authentication system 10 establishes that the key requested from the respective subsystem 20 or 21 does not match a reference key stored in the memory device 11, the method ends.

If the comparison device 13 in the authentication system 10 establishes that the key requested from the subsystem 20 or 21 does match a reference key stored in the memory device 11, on the other hand, then in the next step S5 the last reversibly coded password for the main system 30 which is stored in the memory device 11 in the authentication system 10 is identified by the decoding device 14 in the authentication system 10, is read and is decoded.

The last password stored in the memory device 11 in the authentication system 10 is naturally identified only if the memory device 11 stores a plurality of passwords for the main system. Alternatively, it is also possible to use any other password for the main system which is stored in the memory device 11.

In the next step S6, the password decoded by the decoding device 14 in the authentication system 10 is output to the main system 30 in order to provide the subsystem 20 or 21 with access to the main system 30.

At the same time or alternatively to steps S1 to S6, passwords for the main system 30 can be automatically detected in steps S10 to S13 by the authentication system 10 in the course of a user registering with the main system 30.

For this, in step S10, a user password for the main system 30 is requested by the input device 16 in the authentication system 10, the password being able to be input using the keypad 17 or an alternative input device.

In the next step S11, the password is reversibly coded by the coding device 18 in the authentication system 10.

Next, the reversibly coded password is stored in the memory device 11 in the authentication system 10 by the coding device 18 in step S12.

In the example embodiment shown in FIG. 2a, in the next step S13 the uncoded password is additionally forwarded from the input device 16 in the authentication system 10 to the main system 30 in order to provide the user with access to the main system 30. However, this step is required only if the user actually wishes to access the main system 30 using the password input in step S10. In this context, in the case of fresh creation of a password or in the case of a change to an existing password, the main system 30 uses suitable devices to ensure that the password can be changed or freshly created only by an authorized user.

Even if FIG. 2a shows a sequential arrangement of steps S11, S12 and S13, it is alternatively also possible, of course, for step S13 to take place in parallel with steps S11 and S12.

The decoded password which is output by the output device 15 in the authentication system 10 in step S6 or the password which is forwarded by the input device 16 in the authentication system 10 to the main system 30 in step S13 is encrypted irreversibly by an encryption device 31 in the main system 30 in step S7 or S14.

After steps S7 and S14, the method continues as shown in FIG. 2b.

In step S8, which follows step S7, the password irreversibly encrypted by the encryption device 31 in the main system 30 is compared by a comparator 32 in the main system 30 with an irreversibly encrypted reference password stored on a hard disk 33 in the main system 30.

If the comparison between the password irreversibly encrypted by the encryption device 31 in the main system 30 and the irreversibly encrypted reference passwords stored on the hard disk 33 by the comparator 32 in the main system 30 in step S8 reveals that the irreversibly encrypted password does not match one of the irreversibly encrypted reference passwords, the main system 30 refuses access to the main system 30 in step S16 and the method is terminated.

However, if the comparison between the password irreversibly encrypted by the encryption device 31 in the main system 30 and the irreversibly encrypted reference passwords stored on the hard disk 33 in the main system 30 by the comparator 32 in the main system 30 in step S8 establishes that there is a match between two passwords, access to the main system 30 is enabled by the main system 30 in the subsequent step S9 and the method is terminated.

In the event of a password for the main system 30 being changed or freshly input in steps S10 to S14, the irreversible encryption of the new or changed password by the main system 30 in step S14 is followed by storage of the irreversibly encrypted password as an irreversibly encrypted reference password on the hard disk 33 in the main system 30.

Next, access to the main system 30 is enabled by the main system 30 in step S9 and the method is terminated.

At least one embodiment of the inventive method may be implemented in the form of a computer program product which is suitable for performing a method when it is loaded on a computer.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium (computer program product), is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for providing access for at least one subsystem to at least one password-protected main system using an authentication system, the method comprising:
receiving, by the authentication system, a prescribed key stored in the subsystem;
comparing the received key with a reference key stored in the authentication system;
reading a reversibly coded password for the main system, stored in the authentication system, and decoding the password if the received key matches the reference key; and
outputting the password to the main system, upon being decoded, to provide access for the subsystem.

2. The method as claimed in claim 1, wherein the step of receiving is preceded by the following steps:
recording, by the authentication system, a request by the subsystem to access the main system; and
requesting, by the authentication system, a prescribed key stored in the subsystem.

3. The method as claimed in claim 1, wherein the method also includes the following steps if a plurality of passwords are stored in the authentication system:
identifying the last reversibly coded password stored; and
using the identified password to provide access for the subsystem.

4. The method as claimed in claim 1, further comprising:
irreversibly encrypting, by the main system, the uncoded password received from the authentication system;
comparing the irreversibly encrypted password with an irreversibly encrypted reference password stored in the main system; and
enabling access, via the main system, upon the irreversibly encrypted password matching the irreversibly encrypted reference password.

5. The method as claimed in claim 1, wherein the following steps are provided for the automatic detection of passwords for the main system by the authentication system:
requesting a user password by the authentication system;
reversibly coding the password by the authentication system; and
storing the reversibly coded password by the authentication system.

6. The method as claimed in claim 5, further comprising:
forwarding the uncoded password to the main system by the authentication system, in order to provide access for the user.

7. An authentication system for providing access for at least one subsystem to at least one password- protected main system, the authentication system comprising:
a memory device, adapted to store at least one reference key for the at least one subsystem and at least one reversibly coded password for the main system;
a reception device, adapted to receive a prescribed key stored in the subsystem;
a comparison device, adapted to compare the received key with the at least one reference key stored in the memory device;
a decoding device, adapted to read and decode the at least one reversibly coded password, for the at least one main system which is stored in the memory device, if the received key matches the reference key; and
an output device, adapted to output the password to the main system upon being decoded, in order to provide access for the subsystem.

8. The authentication system as claimed in claim 7, wherein the reception device is also set to record a request by the subsystem for access to the main system and to request a prescribed key stored in the subsystem.

9. The authentication system as claimed in claim 7, wherein the decoding device is also set to identify the last reversibly coded password for the main system which is stored in the memory device, and to use this password to provide access for the subsystem.

10. The authentication system as claimed in claim 7, wherein the main system is set
to encrypt the uncoded password received from the authentication system irreversibly,
to compare the irreversibly encrypted password with an irreversibly encrypted reference password stored in the main system, and
to enable access to the main system if the irreversibly encrypted password matches the irreversibly encrypted reference password.

11. The authentication system as claimed in claim 7 wherein the authentication system comprises, for the purpose of automatically detecting passwords for the main system:
an input device for requesting a user password; and
a coding device for reversibly coding the requested password and storing the reversibly coded password in the memory device.

12. The authentication system as claimed in claim 11, wherein the input device is also set up to forward the uncoded password to the main system in order to provide access for the user.

13. The authentication system as claimed in claim 7, wherein the authentication system is integrated in a medical appliance.

14. The authentication system as claimed in claim 13, wherein the at least one subsystem is an emergency circuit in the medical appliance which allows the medical appliance to operate by accessing the main system without password input.

15. The authentication system as claimed in claim 7, wherein the authentication system and the main system are implemented in the form of different computer programs.

16. A computer program product which is suitable for performing a method as claimed in claim 1, when it is loaded on a computer.

17. The method as claimed in claim 2, wherein the method also includes the following steps if a plurality of passwords are stored in the authentication system:
identifying the last reversibly coded password stored; and
using the identified password to provide access for the subsystem.

18. The method as claimed in claim 2, further comprising:
irreversibly encrypting, by the main system, the uncoded password received from the authentication system;
comparing the irreversibly encrypted password with an irreversibly encrypted reference password stored in the main system; and
enabling access, via the main system, upon the irreversibly encrypted password matching the irreversibly encrypted reference password.

19. The method as claimed in claim 3, further comprising:
irreversibly encrypting, by the main system, the uncoded password received from the authentication system;
comparing the irreversibly encrypted password with an irreversibly encrypted reference password stored in the main system; and
enabling access, via the main system, upon the irreversibly encrypted password matching the irreversibly encrypted reference password.

20. The method as claimed in claim 17, further comprising:
irreversibly encrypting, by the main system, the uncoded password received from the authentication system;
comparing the irreversibly encrypted password with an irreversibly encrypted reference password stored in the main system; and
enabling access, via the main system, upon the irreversibly encrypted password matching the irreversibly encrypted reference password.

21. The authentication system as claimed in claim 8, wherein the decoding device is also set to identify the last reversibly coded password for the main system which is stored in the memory device, and to use this password to provide access for the subsystem.

22. A computer program, adapted to, when executed on a computer, cause the computer to carry out the method as claimed in claim 1.

23. A computer program product, including the computer program of claim 22.

24. An authentication system for providing access for at least one subsystem to at least one password- protected main system, the authentication system comprising:
means for storing at least one reference key for the at least one subsystem and at least one reversibly coded password for the main system;
means for receiving a prescribed key stored in the subsystem;
means for comparing the received key with the at least one reference key stored in the memory device;
means for reading and decoding the at least one reversibly coded password, for the at least one main system which is stored, if the received key matches the reference key; and
means for outputting the password to the main system upon being decoded, in order to provide access for the subsystem.

25. An authentication system for providing access for at least one subsystem to at least one password- protected main system, the authentication system comprising:
means for receiving a prescribed key stored in the subsystem;
means for comparing the received key with a reference key stored in the authentication system;
means for reading a reversibly coded password for the main system, stored in the authentication system, and for decoding the password if the received key matches the reference key; and
means for outputting the password to the main system, upon being decoded, to provide access for the subsystem.
